(19) United States
(12) Patent Application Publication
(10) Pub. No.: US 2025/0209167 A1
(43) Pub. Date: Jun. 26, 2025

(54) BLOCKCHAIN-BASED BUSINESS CONTINUITY SYSTEM AND METHOD FOR MALWARE AND RANSOMWARE DEFENSE

(71) Applicant: SAUDI ARABIAN OIL COMPANY, Dhahran (SA)

(72) Inventors: Abdulmalik Abdulaziz Aljurayyad, Dammam (SA); Sultan Saadaldean Alsharif, Dammam (SA)

(73) Assignee: SAUDI ARABIAN OIL COMPANY, Dhahran (SA)

(21) Appl. No.: 18/394,847

(22) Filed: Dec. 22, 2023

(51) Int. Cl. G06F 21/56; G06F 21/55

(52) U.S. Cl. CPC G06F 21/565; G06F 21/554; G06F 21/564

(57) ABSTRACT

Harm caused from malware is automatically prevented. Each of a plurality of hardware facilities are configured by at least one computing device. The hardware facilities interact on a decentralized data communication network and automatically transmit, as a function of a smart contract, a request to another of the plurality of hardware facilities for data associated with a new file or an update to an existing file. In response to the request, data are received and processed to automatically determine, as a function of the smart contract, the data malware or a file infected with malware. The configured hardware facilities are configured to execute, in response to detecting the malware or infection with malware as a function of the smart contract, an instruction to be executed by the other of the plurality of hardware facilities to cause a cybersecurity software application to mitigate any threat caused by the malware.

### FIELD OF THE DISCLOSURE

The present invention relates, generally, to cybersecurity and, more particularly, to implementing blockchain technologies to defend against malware.

### BACKGROUND OF THE DISCLOSURE

Malware attacks, such as from computer viruses and ransomware, pose a significant threat to businesses, including for disrupting operations, compromising sensitive data, and causing significant financial losses. Unfortunately, known cybersecurity measures, including antivirus software and firewalls, can be ineffective to defend against such attacks, as they rely on known threat signatures and can be bypassed by sophisticated attackers.

It is respect to these and other concerns that the present disclosure is made.

### BRIEF SUMMARY

In one or more implementations, a computer-implemented method and system are provided for automatically preventing harm caused from malware. Each of a plurality of hardware facilities are configured, by at least one computing device configured by executing instructions, to perform steps including to interact on a decentralized data communication network. Further, the hardware facilities are configured to automatically transmit, as a function of a smart contract, a request to an other of the plurality of hardware facilities for data associated with a new file or an update to an existing file. Moreover, the hardware facilities are configured to receive, in response to the request from the other the of plurality of hardware facilities, the requested data. Thereafter, the hardware facilities are configured to process the requested data to automatically determine, as a function of the smart contract, the data represents the new file or the update to the existing file is malware or infected with malware. Further, the hardware facilities are configured to automatically execute, in response to the step of detecting the malware or infection with malware as a function of the smart contract, an instruction to be executed by the other of the plurality of hardware facilities to cause a cybersecurity software application to mitigate any threat caused by the malware.

In one or more implementations of the present disclosure, the step of determining the data represents the new file or the update to the existing file is malware or infected with malware includes heuristics, machine learning, and artificial intelligence.

In one or more implementations of the present disclosure, the step of configuring each of the plurality of hardware facilities further includes providing, on each of the plurality of hardware facilities, a graphical user interface.

In one or more implementations of the present disclosure, the malware includes at least one of ransomware, spyware, a trojan, a worm, and virus.

In one or more implementations of the present disclosure, the request for data associated with a new file or an update to an existing file is provided via an application programming interface call.

In one or more implementations of the present disclosure, the data associated with a new file or an update to an existing file is a file hash.

In one or more implementations of the present disclosure, the step of configuring each of the plurality of hardware facilities further includes notifying each of the plurality of hardware facilities that the data represents the new file or the update to the existing file is malware or infected with malware.

In one or more implementations of the present disclosure, the threat is mitigated by quarantining the new file or the existing file.

### BRIEF DESCRIPTION OF THE FIGURES

Aspects of the present disclosure will be more readily appreciated upon review of the detailed description of its various embodiments, described below, when taken in conjunction with the accompanying drawings, of which:

FIG. 1 is a simple block diagram illustrating an example plurality of computing nodes, each configured with one or more software applications and linked to the other nodes, in accordance with an example implementation of the present disclosure;

FIG. 2 illustrates an example decentralized IT infrastructure, including with respect to one or more blockchain networks, including hardware facilities and software facilities, in accordance with an example implementation of the present application;

FIG. 3 illustrates an example hardware facility 202 and corresponding software facilities for implementing features shown and described herein;

FIG. 4 illustrates, in block diagram form, an exemplary hardware facility 102 that can provide functionality in accordance with the teachings herein; and

FIG. 5 is a flow chart illustrating an example process 500 including steps that are associated with automatically preventing harm caused by malware, in accordance with an example implementation of the present disclosure.

### DETAILED DESCRIPTION OF ONE OR MORE EMBODIMENTS

The present disclosure provides a computer-implemented solution for preventing harm caused by malware, such as ransomware, spyware, trojans, worms, viruses, or the like (collectively, “malware”). Blockchain technology is employed to provide protection via one or more decentralized, secure networks, including by storing and transferring data in a tamper-evident manner. For example, data records can be stored in an immutable ledger thereby precluding erroneous evidence of data alteration. Moreover, smart contracts can be used on the blockchain to execute terms automatically, automate processes, and enforce predetermined rules and procedures in to prevent or manage detected malware, such as ransomware, viruses, or the like. As known to those skilled in the art, smart contracts include programming instructions stored on a blockchain, which execute automatically in response to detection of one or more terms and conditions. Upon such detection, smart contracts can automatically execute the instructions without involvement or time loss incurred by an individual user of one or more nodes. Workflows in response to detection of a threat or event can be automated, including initial acts and sequential operations, until resolution of the particular terms and conditions.

The present disclosure can implement smart contract technology for computer network defense as a function of executing code and over a blockchain framework. For example, a business continuity system is provided that utilizes blockchain technology to defend against malware attacks, such as from virus and ransomware, and provides a secure and reliable means of protection against and mitigating associated threats.

In one or more implementations of the present disclosure, a decentralized network of computers, each running a copy of the blockchain and a software application for detecting and mitigating malware threats, is employed. Smart contracts and cryptographic techniques are utilized to store and transfer data securely, and to enforce predetermined rules and procedures for responding to malware threats, such as from computer viruses and ransomware. The smart contracts can include instructions to scan new files, as well as updated files, using one or more software applications and to notify one or more computing devices of a threat. In addition, smart contracts can operate to quarantine infected files or systems automatically and to notify relevant parties of quarantined file(s). Moreover, the present disclosure includes a user interface that includes graphical screen controls, such as buttons, checkboxes, dropdown lists, textboxes, or other suitable controls that enable a user to manage and monitor one or more computer systems and networks, and for enabling authorized users to access and modify data stored on the blockchain. The user interface can be web-based or provided on one or more local computing devices. Utilizing a user interface for managing and monitoring the system from a cybersecurity perspective can include features for anomaly detection. For example, unusual patterns can be identified that indicate security threats. Such patterns can be compared in real-time data to established baselines, thereby adding an additional cybersecurity layer.

In one or more implementations of the present disclosure the user interface includes a dashboard providing cybersecurity status information, including a display of the overall count of nodes in the blockchain network. Other information provided in the dashboard can include a number of nodes that have been scanned for potential malware threats, a total count of malware instances that have been detected and quarantined, as well as information representing anomalous activity or behavior detected within the blockchain network. Moreover, the dashboard can include information representing real-time alerts for any ongoing or recently identified malware threats or suspicious activities, as well as a total number of transactions processed by the blockchain, as well as any spikes or unusual patterns.

In one or more implementations of the present disclosure, a user interface can include selectable options, such as for creating custom alerts and enabling users to set up custom alerts and notifications for events of interest, based on specific criteria. Other selectable options can enable users to create custom views, such as to allow users to create their own views and add custom views to a main dashboard. Further, options can be provided for users run scans, such to execute new scans locally on the users' respective machines, as well as to export specific reports at specific times or covering specific time periods.

Further, one or more user interfaces provided in accordance with the present disclosure can include starting processes, such as to run a scan. Such option(s) can be provided for manual execution or, in case of a node operating in an administrative mode, at scheduled times. Each nodes can be configured with a user interface that resents cybersecurity information status of the respective node, such as information representing the node status, the time/date and results of last scan, quarantined malware, total number of nodes, or the like. One or more nodes operating as an administrator or a computer behind a firewall can manage and maintain system criteria via an administrator user interface, which can present multiple views, scans scheduled to run on respective nodes, as well as to update one or more computing devices with current malware signatures.

Accordingly, the disclosed business continuity system utilizes a decentralized network of computers, each running a copy of the blockchain and one or more respective software applications for detecting and mitigating malware threats. In one or more implementations, any suitable blockchain frameworks, such as ETHEREUM or HYPERLEDGER FABRIC, can be employed.

In one or more implementations of the present disclosure, one or more software applications executing on one or more computing devices can detect threats and mitigate harm from malware, such as from computer viruses and ransomware. The application can use a variety of techniques, such as machine learning and heuristics, to identify and classify threats. It can also communicate with other software applications and devices on the network to gather information about potential threats and to coordinate response efforts. Machine learning can employ different algorithms to increase detection rates and cover multiple threat types. For example, a first algorithm, Support Vector Machines (SVM), can be effective for binary classification tasks and can be used for malware detection. A second algorithm, Recurrent Neural Network (RNN), is suitable for sequence-based data such as analyzing network traffic patterns. For datasets, VirusTotal dataset can be used for malware signatures and classifications. Moreover, the UNSW-NB15 dataset can be used for traffic activities, as it provides a labeled network security dataset that includes normal and attack traffic.

In one or more implementations, training operations can begin with data preprocessing (e.g., loading and preprocessing malware datasets). Thereafter, relevant features can be extracted and the dataset split into a training set and a testing set. Training results in the model obtaining a high accuracy of detection. For example, a file is infected with malware used to establish outbound connection to command and control server. The trained model, via machine learning, automatically detects a pattern as malicious and quarantines the file.

Once trained, one or more computing devices can be configured for automatic updates including current security patches and malware definitions, ensuring that operations remain up-to-date and able to effectively defend against new threats. Moreover, respective conventional security measures, such as firewalls and intrusion detection systems, can be included to provide a robust and comprehensive defense against malware and ransomware attacks.

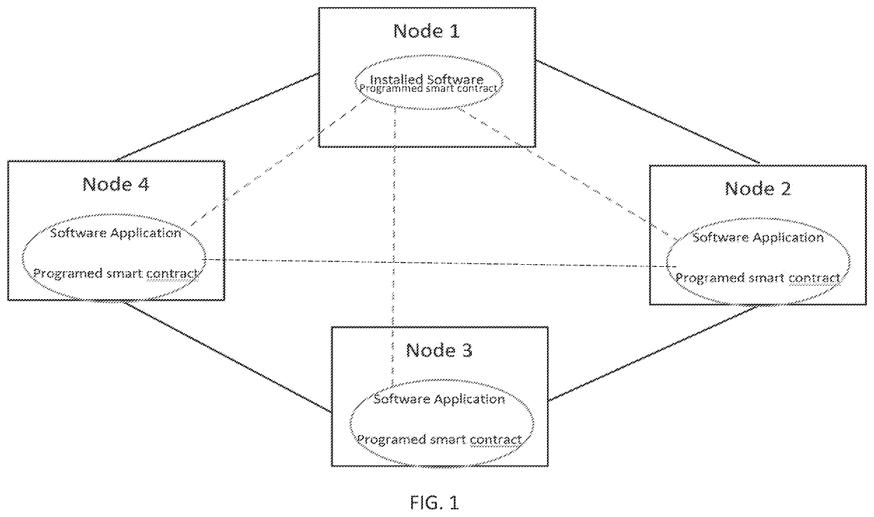

Referring now to the drawings, FIG. 1 is a simple block diagram illustrating an example plurality of computing nodes, Node 1, Node 2, Node 3, and Node 4, each configured with one or more software applications and linked to the other nodes. Node 2, Node 3, and Node 4 are further configured with a smart contract for further processing, such as shown and described herein. The software application(s), when executing on one or more nodes, operate to detect and mitigate malware threats. The smart contracts included with the nodes include instructions to trigger a scan of any updated or downloaded file, for example, using the software application, and notify Node 1. In addition, the smart contracts can quarantine infected files or systems automatically, and notify relevant parties of the threat.

In one or more implementations, the present disclosure includes a cybersecurity system that includes malware detection and installed on Node 1 (FIG. 1). Other nodes on the blockchain, e.g., Nodes 2-4 (FIG. 1) include self-executing code (e.g., smart contracts) that operate to fetch data (e.g., file hashes) periodically from each of the other nodes and send the data therefrom to node 1 for further operations. Node 1 receives the data and scans the received data for malware, viruses, or the like. Provided no threats are detected, Node 1 can delete the received data.

Accordingly, the present disclosure utilizes a blockchain framework to interface with a cybersecurity platform that is operable for malware detection and remediation. Smart contracts can configure nodes on the blockchain to connect to the cybersecurity platform and provide data, such as file hashes, for subsequent scanning for, for example, malware signatures. In one or more implementations, functions can be transmitted as application programming interface (“API”) calls in a server/client environment. For example and with reference to FIG. 1, software installed on Node 1 configures Node 1 to be an API server that receives data and scans the data for malware, such as a computer virus, ransomware, or other malicious software.

For example, transferred information between APIs can include cybersecurity information representing each node and can include the following details:
Action: request_scan/scan_result;
Node ID: ID_number;
Node status: online/offline; and
Smart contract results: detected malware/no malware found
   In one or more implementations, communications between APIs are encrypted, such as via HTTPS, to ensure all transmitted data are encrypted.

Unlike known use of a blockchain, which operate largely to scan a new block before adding the block to the network, the present disclosure includes technology for continual scanning of nodes and files, to ensure no malware is installed or affecting any node. Further, the present disclosure uses smart contract technology to interface with cybersecurity technology, including installed on one or more respective nodes, to redress threats from malware. The result is a new approach to secure a blockchain environment and one or more nodes operating outside of a blockchain (e.g., within the enterprise) via smart contract technology.

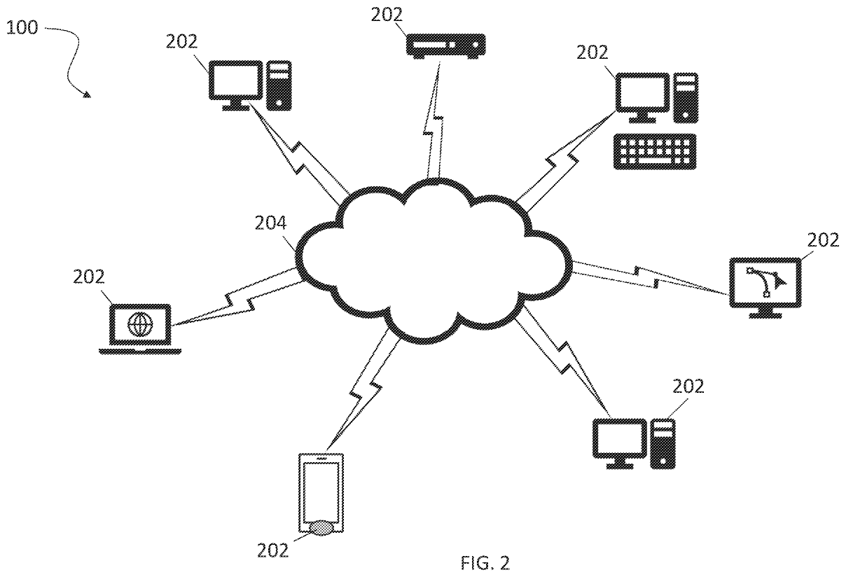

Referring now to FIG. 2, a decentralized IT infrastructure 200, including with respect to one or more blockchain networks, can include hardware facilities 202 and software facilities 302. Software facilities 302 can include, for example, blockchain processor facilities, network facilities, data facilities, and end-user facilities. Processor facilities can include, for example, file servers, email servers, web servers, and virtual servers. Networking facilities can include, for example, hubs, switches, routers, and access points. Data facilities can include enterprise-wide data centers, managed service data centers, and cloud data centers. End user facilities can include, for example, desktop computers, laptop computers, and mobile computing device (e.g., tablet computing devices and smartphones). Software facilities can include blockchain network software, smart contract software systems, cybersecurity applications, content management systems, customer relations management systems, enterprise resource management systems, email systems, operating systems, and web-site content. These examples illustrate just a few of the many complex and interrelated hardware and software facilities comprised in information technology infrastructures, and the teachings set forth in the present disclosure are applicable to various forms thereof. While the present disclosure includes representative examples of an IT infrastructure comprising hardware and software facilities associated with email, such as MICROSOFT EXCHANGE, it is to be understood and appreciate that the systems and methods set forth herein are effectively applicable in connection with many IT infrastructures and hardware and software facilities associated therewith. Interactivity can occur via one or more data communication networks 204, e.g., the internet, an enterprise wide area network, one or more local area networks, wireless networks, virtual private networks, or other suitable configurations.

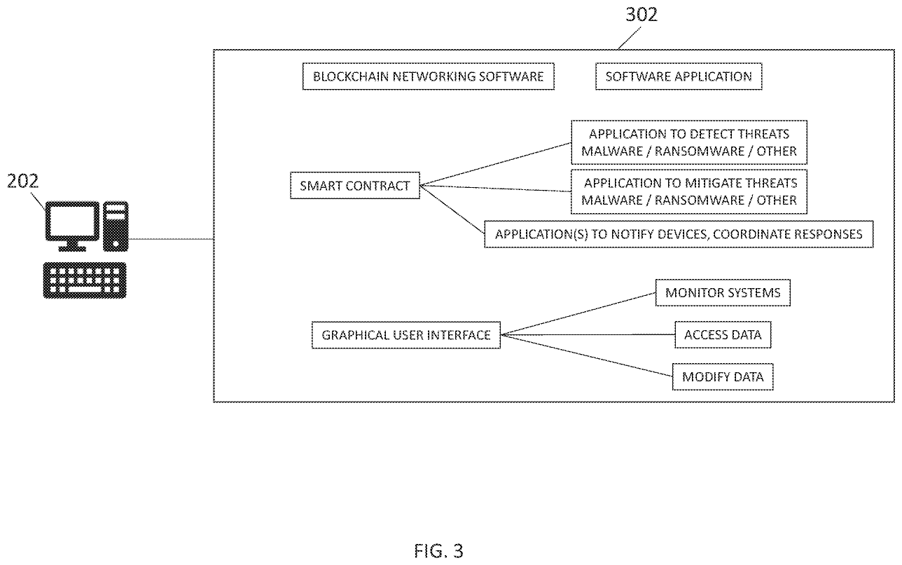

FIG. 3 illustrates an example hardware facility 202 and corresponding software facilities for implementing features shown and described herein. For example, hardware facility 202 can be configured with one or more blockchain frameworks and software applications. One or more smart contracts can include programming instructions to detect malware threats. A hardware facility 202 configured with one or more smart contracts can execute one or more instructions to cause an application (e.g., a cybersecurity software application) to mitigate threats and malicious activity associated with malware. The smart contract(s) can also interface with one or more software applications to notify devices associated with malware and coordinate responses thereto. In addition, hardware facility 202 can be configured one or more graphical user interfaces that provide functionality, such as relating to malware detection, smart contract execution, and administrative processes.

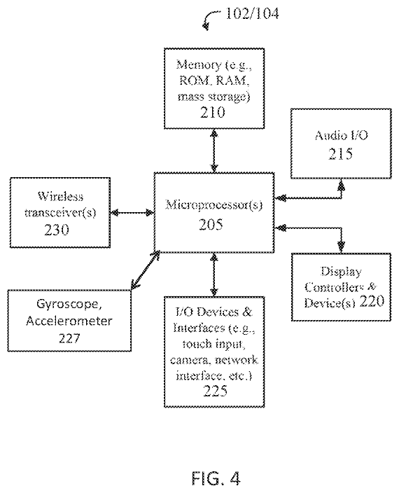

FIG. 4 illustrates, in block diagram form, an exemplary hardware facility 102 that can provide functionality in accordance with the teachings herein. Although not expressly indicated, one or more features shown and described with reference to FIG. 4 can be included with or in an audio/visual capture device, as well. Hardware facility 102 may include one or more microprocessors 405 and connected system components (e.g., multiple connected chips) or the hardware facility 102 may be a system on a chip.

The hardware facility 102 includes memory 410 which can be coupled to the microprocessor(s) 405. The memory 410 may be used for storing data, metadata, and programs for execution by the microprocessor(s) 405. The memory 410 may include one or more of volatile and non-volatile memories, such as Random Access Memory (“RAM”), Read Only Memory (“ROM”), Flash, Phase Change Memory (“PCM”), or other type of memory. Accordingly, hardware facility 102 can be configured with non-transitory processor readable media, such as described herein.

The hardware facility 102 can also include an audio input/output subsystem 415 which may include a microphone and/or a speaker for, for example, playing back video, providing telephone or voice/video chat functionality through the speaker and microphone, etc.

A display controller and display device 420 provides a visual user interface for the user; this user interface may include a graphical user interface which, for example, is similar to that shown on a Macintosh computer when running Mac OS operating system software or an iPad, iPhone, or similar device when running mobile computing device operating system software.

The hardware facility 102 also includes one or more wireless transceivers 430, such as an IEEE 802.11 transceiver, an infrared transceiver, a Bluetooth transceiver, a wireless cellular telephony transceiver (e.g., 1G, 2G, 3G, 4G, 5G), or another wireless protocol to connect the data processing system 100 with another device, external component, or a network.

It will be appreciated that one or more buses, can be used to interconnect the various modules in the block diagram shown in FIG. 4.

The hardware facility 102 may be a personal computer, tablet-style device, such as an iPad, a personal digital assistant (PDA), a cellular telephone with PDA-like functionality, such as an iPhone, a Wi-Fi based telephone, a handheld computer which includes a cellular telephone, a media player, such as an iPod, an entertainment system, such as a iPod touch, or devices which combine aspects or functions of these devices, such as a media player combined with a PDA and a cellular telephone in one device. In other embodiments, the hardware facility 102 may be a network computer or an embedded processing apparatus within another device or consumer electronic product.

The hardware facility 102 also includes one or more input or output (“I/O”) devices and interfaces 425 which are provided to allow a user to provide input to, receive output from, and otherwise transfer data to and from the system. These I/O devices may include a mouse, keypad or a keyboard, a touch panel or a multi-touch input panel, camera, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one, two, three, or more touches and is capable of providing inputs derived from those touches to the hardware facility 102. The I/O devices and interfaces 425 may include a connector for a dock or a connector for a USB interface, FireWire, etc. to connect the hardware facility 102 with another device, external component, or a network.

Moreover, the I/O devices and interfaces can include gyroscope and/or accelerometer 427, which can be configured to detect 3-axis angular acceleration around the X, Y and Z axes. Moreover, various other sensor components can be configured with the hardware facility 102, as suitably useful in accordance with the teachings herein.

It will be appreciated that additional components, not shown, may also be part of the hardware facility 102, and, in certain embodiments, fewer components than that shown in FIG. 4 may also be used in the hardware facility 102. It will be apparent from this description that aspects can be embodied, at least in part, in software. That is, the computer-implemented methods may be carried out in a computer system or other data processing system in response to its processor or processing system executing sequences of instructions contained in a memory, such as memory 410 or other machine-readable storage medium. The software may further be transmitted or received over a network (not shown) via a network interface device 425. In various embodiments, hardwired circuitry may be used in combination with the software instructions to implement the present embodiments. Thus, the techniques are not limited to any specific combination of hardware circuitry and software, or to any particular source for the instructions executed by the hardware facility 102.

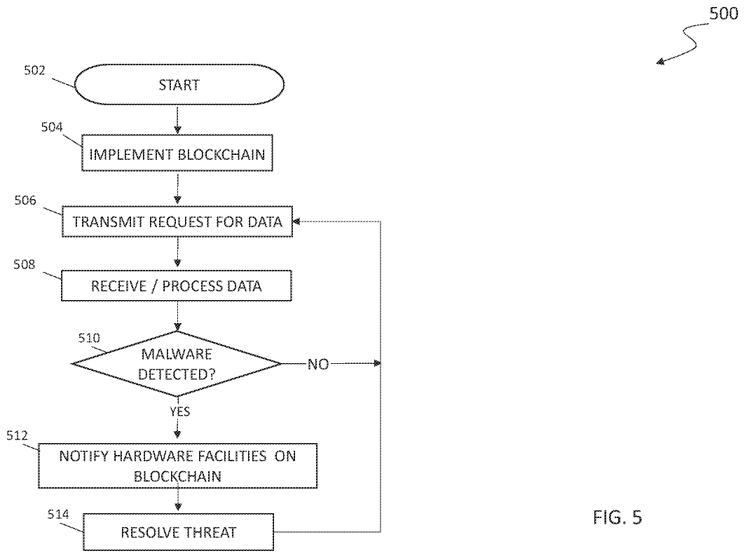

FIG. 5 is a flow chart illustrating an example process 500 including steps that are associated with automatically preventing harm caused by malware, in accordance with an example implementation of the present disclosure. It should be appreciated that several of the logical operations described herein are implemented (1) as a sequence of computer implemented acts or program modules running on a communication device and/or (2) as interconnected machine logic circuits or circuit modules within a communication device. The implementation is a matter of choice dependent on the requirements of the device (e.g., size, energy, consumption, performance, etc.). Accordingly, the logical operations described herein are referred to variously as operations, structural devices, acts, or modules. Several of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Continuing with reference to FIG. 5, at step 502 the process starts and each of a plurality of hardware facilities are configured to perform steps including to interact on a decentralized data communication network, e.g., a blockchain (step 504). At step 506, a request by one of the hardware facilities to another of the plurality of hardware facilities for data associated with a new file or an update to an existing file is automatically transmitted. The request for data can be automatically transmitted as a function of a smart contract executed on the blockchain by the one of the hardware facilities. Thereafter, in response to the request from the other of the plurality of hardware facilities, the requested data are received and processed (step 508). Processing occurs automatically, as of a function of the smart contract, to determine whether malware is detected (step 510). For example, the new file or the updated existing file may be malware or infected therewith.

Continuing with reference to FIG. 5, if the determination at step 510 is no malware is detected, then the process branches back to step 506. Alternatively, the process branches to step 512 and hardware facilities on the blockchain are notified of the determination. Thereafter, the process continues to step 514, and the threat is resolved. More particularly, in response to detecting the malware or infection with malware, an instruction is executed as a function of the smart contract for the other of the plurality of hardware facilities to cause a cyber security software application to mitigate the threat caused by the malware. Thereafter, the process branches back to step 506.

Accordingly, the present disclosure provides systems and methods for automating preventing harm caused by malware, such as ransomware, spyware, trojans, worms, viruses, or the like. Moreover, slight modifications to the steps shown and described herein can be implemented, such as by removing any pausing following completion of a respective step. Moreover, human error and manual steps can be eliminated by the features shown and described herein, and efficiency is markedly improved.

The terms “a,” “an,” and “the,” as used in this disclosure, means “one or more,” unless expressly specified otherwise.

The term “communicating device,” as used in this disclosure, means any hardware, firmware, or software that can transmit or receive data packets, instruction signals or data signals over a communication link. The hardware, firmware, or software can include, for example, a telephone, a smart phone, a personal data assistant (PDA), a smart watch, a tablet, a computer, a software defined radio (SDR), or the like, without limitation.

The terms “computer” or “computing device,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a server farm, a computer cloud, or the like, or an array of processors, microprocessors, central processing units, general purpose computers, super computers, personal computers, laptop computers, palmtop computers, notebook computers, desktop computers, workstation computers, servers, or the like, without limitation.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM).

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, Wi-Fi, WiMAX, IEEE 802.11, DECT, 0G, 1G, 2G, 3G, 4G, or 5G cellular standards, Bluetooth, or the like.

The terms “transmission” and “transmit,” as used in this disclosure, refer to the conveyance of signals via electricity, acoustic waves, light waves and other electromagnetic emissions, such as those generated in connection with communications in the radio frequency (RF) or infrared (IR) spectra. Transmission media for such transmissions can include coaxial cables, copper wire and fiber optics, including the wires that comprise a system bus coupled to the processor.

The term “database,” as used in this disclosure, means any combination of software and/or hardware, including at least one application and/or at least one computer. The database can include a structured collection of records or data organized according to a database model, such as, for example, but not limited to at least one of a relational model, a hierarchical model, a network model or the like. The database can include a database management system application (DBMS) as is known in the art. The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including,” “comprising” and variations thereof, as used in this disclosure, mean “including, but not limited to,” unless expressly specified otherwise.

The term “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which can be configured to communicate data via a wireless and/or a wired communication medium. These networks can run a variety of protocols not limited to TCP/IP, IRC or HTTP.

The term “server,” as used in this disclosure, means any combination of software and/or hardware, including at least one application and/or at least one computer to perform services for connected clients as part of a client-server architecture. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, including as indicated by a respective reference numeral, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The present disclosure has been described with reference to the accompanying drawings, which form a part hereof, and which show, by way of illustration, example implementations. As such, the figures and examples above are not meant to limit the scope of the present disclosure to a single implementation, as other implementations are possible by way of interchange of some or all of the described or illustrated elements, without departing from the spirit of the present disclosure. Among other things, for example, the disclosed subject matter can be embodied as methods, devices, components, or systems.

Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Furthermore, it is recognized that terms used herein can have nuanced meanings that are suggested or implied in context beyond an explicitly stated meaning. Likewise, the phrase “in one implementation” as used herein does not necessarily refer to the same embodiment and the phrase “in one or more implementations” as used herein does not necessarily refer to different implementations. It is intended, for example, that claimed subject matter can be based upon combinations of individual example implementations, or combinations of parts of individual example implementations.

The foregoing description of the specific implementations will so fully reveal the general nature of the disclosure that others can, by applying knowledge within the skill of the relevant art(s) (including the contents of the documents cited and incorporated by reference herein), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown of drawings are shown accordingly to one example and other dimensions can be used without departing from the present disclosure.

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described example implementations, and the disclosure is to be understood as being defined by the recitations in the claims which follow and structural and functional equivalents of the features and steps in those recitations.

What is claimed:

1. A computer-implemented method for automatically preventing harm caused from malware, the method comprising:
configuring each of a plurality of hardware facilities, by at least one computing device configured by executing instructions, to perform the following steps:
interact on a decentralized data communication network;
automatically transmit, as a function of a smart contract, a request to an other of the plurality of hardware facilities for data associated with a new file or an update to an existing file;
receive, in response to the request from the other the of plurality of hardware facilities, the requested data;
process the requested data to automatically determine, as a function of the smart contract, the data represents the new file or the update to the existing file is malware or infected with malware; and
automatically execute, in response to the step of detecting the malware or infection with malware as a function of the smart contract, an instruction to be executed by the other of the plurality of hardware facilities to cause a cybersecurity software application to mitigate any threat caused by the malware.

2. The computer-implemented method of claim 1, wherein the step of determining the data represents the new file or the update to the existing file is malware or infected with malware includes heuristics, machine learning, and artificial intelligence.

3. The computer-implemented method of claim 1, wherein the step of configuring each of the plurality of hardware facilities further includes:
providing, on each of the plurality of hardware facilities, a graphical user interface.

4. The computer-implemented method of claim 1, wherein the malware includes at least one of ransomware, spyware, a trojan, a worm, and virus.

5. The computer-implemented method of claim 1, wherein the request for data associated with a new file or an update to an existing file is provided via an application programming interface call.

6. The computer-implemented method of claim 1, wherein the data associated with a new file or an update to an existing file is a file hash.

7. The computer-implemented method of claim 1, wherein the step of configuring each of the plurality of hardware facilities further includes:
notifying each of the plurality of hardware facilities that the data represents the new file or the update to the existing file is malware or infected with malware.

8. The computer-implemented method of claim 1, wherein the threat is mitigated by quarantining the new file or the existing file.

9. A computer-implemented system for automatically preventing harm caused from malware, the system comprising:
at least one computing device, wherein the at least one computing device is configured by executing instructions for:
configuring each of a plurality of hardware facilities, by at least one computing device configured by executing instructions, to perform the following steps:
interact on a decentralized data communication network;
automatically transmit, as a function of a smart contract, a request to an other of the plurality of hardware facilities for data associated with a new file or an update to an existing file;
receive, in response to the request from the other the of plurality of hardware facilities, the requested data;
process the requested data to automatically determine, as a function of the smart contract, the data represents the new file or the update to the existing file is malware or infected with malware; and
automatically execute, in response to the step of detecting the malware or infection with malware as a function of the smart contract, an instruction to be executed by the other of the plurality of hardware facilities to cause a cybersecurity software application to mitigate any threat caused by the malware.

10. The computer-implemented system of claim 9, wherein the step of determining the data represents the new file or the update to the existing file is malware or infected with malware includes heuristics, machine learning, and artificial intelligence.

11. The computer-implemented system of claim 9, wherein the step of configuring each of the plurality of hardware facilities further includes:
providing, on each of the plurality of hardware facilities, a graphical user interface.

12. The computer-implemented system of claim 9, wherein the malware includes at least one of ransomware, spyware, a trojan, a worm, and virus.

13. The computer-implemented system of claim 9, wherein the request for data associated with a new file or an update to an existing file is provided via an application programming interface call.

14. The computer-implemented system of claim 9, wherein the data associated with a new file or an update to an existing file is a file hash.

15. The computer-implemented system of claim 9, wherein the step of configuring each of the plurality of hardware facilities further includes:
notifying each of the plurality of hardware facilities that the data represents the new file or the update to the existing file is malware or infected with malware.

16. The computer-implemented system of claim 9, wherein the threat is mitigated by quarantining the new file or the existing file.
